(19) United States
(12) Patent Application Publication
(10) Pub. No.: US 2010/0272548 A1
(43) Pub. Date: Oct. 28, 2010

(54) CAN CADDY DEVICE

(76) Inventor: MICKEY McKAMEY, King Sport, TN (US)

Correspondence Address: Thien Tran/ Access Patent Group, LLC, 7706 Tanner Robert Court, Springfield, VA, 22153, US

(21) Appl. No.: 12/765,846

(22) Filed: Apr. 22, 2010

Related U.S. Application Data
(60) Provisional application No. 61/171,498, filed on Apr. 22, 2009.

(51) Int. Cl. B60R 9/06; B66D 1/04

(52) U.S. Cl. 414/462; 254/323; 254/342

(57) ABSTRACT

A can caddy device for lifting and transporting a refuse container by a motor vehicle. The device includes a horizontally extending hitch bar that is mounted into a standard hitch receiver on a back of the motor vehicle. A vertical track member has a bottom end secured to a distal end of the horizontally extending hitch bar. A vertical slide member has an inner portion which rides within the vertical track member. A winch mechanism on a top end of the vertical track member is for manually raising and lowering the vertical slide member. The winch mechanism includes two coupling gears. A structure on the vertical slide member is for engaging the refuse container. A manual crank handle which removably engages with a T-connector of said winch to manually operated said winch in order to manually raise and lower said vertical slide member which carries the refuse container. Optionally, a motorized winch can be used in replacement of the manual crank handle.

### CROSS-REFERENCE TO RELATED APPLICATION

This application claims the benefit of Provisional Patent Application No. 61171498, filed on Apr. 22, 2009, in the United States Patent & Trademark Office, the disclosure of which is incorporated herein by reference.

### BACKGROUND OF THE INVENTION

1. Field of the Invention

The present invention relates to a receptacle transporter, and more particularly, a can caddy device.

At least once a week, homeowners must transport their refuse containers curbside for pick-up. For many, this process can be extremely strenuous. City issued containers are capable of holding a large amount of refuse, which makes them uncomfortably heavy. Those with long driveways find themselves dragging the containers a great distance. The elderly and those with disabilities often need assistance to move the containers. If there is no one available to help, they may not be able to get their refuse picked up. An easier way of transporting the containers is needed.

2. Description of the Prior Art

Numerous innovations for transporting apparatuses have been provided in the prior art that will be described. Even though these innovations may be suitable for the specific individual purposes to which they address, however, they differ from the present invention.

A FIRST EXAMPLE, U.S. Pat. No. 5,738,261, Issued on Apr. 14, 1998, to Dula teaches a base plate that is securable to a vehicle bumper using a threaded bolt attachment and supports a rectangular support which in turn is secured to and supports a planar top plate. A front plate is angularly positioned between the top plate and base plate to provide the combined support structure of a vehicle hitch securable to a vehicle bumper. A transversely extending saddle plate is spaced from the front plate at the lower edge thereof defining a lower channel therebetween. A pair of latch arms each defining respective notches therein are pivotally supported upon the vertical support and are coupled to a transversely extending angularly disposed cam plate. A return spring is operative to urge the latch arms to an upward locking position. An elongated handle is secured to one of the latch arms and extends downwardly therefrom. A pool cart or the like having an upper tube and lower tube is received within the latch arm notches and lower channel respectively to secure the pool cart to the vehicle hitch. Embodiments are shown having a coil type return spring and one or more torsion type return springs.

A SECOND EXAMPLE, U.S. Pat. No. 5,860,659, Issued on Jan. 19, 1999, to Hart teaches a carrier or cart for holding and transporting two or more containers, in particular, garbage/trash cans or bins. The cart is designed for easy maneuverability to facilitate storage and simultaneous transport of multiple containers.

A THIRD EXAMPLE, U.S. Pat. No. 6,164,896, Issued on Dec. 26, 2000, to Cummins teaches a trash container lifting device adapted for attachment to a motor vehicle for lifting and transporting a filled trash container to a remote site for pickup. The lifting device includes a supporting frame which is attached to the motor vehicle, such as a pickup truck, sport utility vehicle or the like without tools or attaching hardware. The supporting frame is mechanically coupled to an articulating frame for engaging a trash container on the ground surface and lifting it with a manual lever to a raised position for transport by the vehicle. At least one spring extends between the supporting frame and the articulating frame to provide the user with a mechanical advantage in lifting a loaded container which would otherwise be an unmanageable task for a single individual. The lifting device is adaptable to trash containers of various sizes and configurations with minor modifications.

A FOURTH EXAMPLE, U.S. Pat. No. 6,361,264, Issued on Mar. 26, 2002, to Guthrie et al. teaches a transporter which is attachable to the tow package of a vehicle for transporting a container from one place to another. The transporter includes a lifter which manually engages, lifts and holds the container for transportation.

A FIFTH EXAMPLE, U.S. Pat. No. 6,698,995, Issued on Mar. 2, 2004, to Bik et al. teaches a hitch mountable refuse container transport device which has a vertical element supporting a telescoping mount that carries T-bar keys on a horizontal bracket. Each key has a horizontal surface sized to be received within a recessed portion on the refuse container and engage a lip on an upper periphery of the recessed portion. Adjustment of the telescoping mount lifts the containers for transport.

A SIXTH EXAMPLE, U.S. Patent Office Publication No. 2004/0232184, Published on Nov. 25, 2004, to Moen teaches a receptacle for use with a vehicle equipped with a vehicle receiver. The vehicle tow accessory attaches to a vehicle receiver and facilitates the transport of trash receptacles along driveways or small roads. The invention comprises separate parts that allow for adjustments to accommodate trash receptacles of various sizes. In the preferred embodiment of the invention, a trash receptacle tilts back to lean on a platform of the invention and is secured via chains or tethers.

A SEVENTH EXAMPLE, U.S. Patent Office Publication No. 2005/0023796, Published on Feb. 3, 2005, to Rasmussen teaches a waste receptacle transport device which consists of a vehicle attachment device being connected to a waste receptacle attachment device. The vehicle attachment device can be angularly adjustable to accommodate adhesion to a variety of body surfaces of tow vehicles. In addition, the waste receptacle attachment device is attachable to waste receptacles having a variety of shapes and sizes. When the waste receptacle transport device is attached between the respective tow vehicle and waste receptacle, the waste receptacle transport device is able to tow the waste receptacle using wheels on the waste receptacle from a first location to a second location. The waste receptacle may be towed without regard to inclement weather and adverse terrain. Alternatively, the waste receptacle transport device can be integral to the waste receptacle to form a towable waste receptacle.

AN EIGHTH EXAMPLE, U.S. Patent Office Publication No. 2005/0161906, Published on Jul. 28, 2005, to Thelen teaches vehicle attachments, in particular to a device that enables vehicle-powered towing of large, wheeled refuse containers. The devices used in this invention disclose a support structure which accommodates a variety of vehicle hitch and refuse container heights, a hook attached in a way to permit large vertical motion while rotational motion about a vertical axis is restricted, and a movable locking device that is integral to the hook. The support structure mounts into a typical trailer hitch receiver mounted to a vehicle. A transverse snubber bar extending from the support structure prevents the container from being crushed in the event of vehicle reversal. The hook is attached to the support structure and is configured to connect to an element on a large wheeled refuse container, then allows that connection point to be vertically repositioned tipping the container forward. This action allows the center of gravity of the container to be rotated from behind the containers wheels, to a point forward of the wheels for towing.

A NINTH EXAMPLE, U.S. Pat. No. 6,953,199, Issued on Oct. 11, 2005, to Malloy III teaches a container assembly designed for the collection, temporary storage and transport of refuse, waste material or other objects including a housing having a hollow interior in which the refuse is collected and stored and further including a supplementary support structure movably mounted on the housing and selectively positionable between an operative position and a stored position. The supplementary support structure is at least partially defined by a support platform which, when in the operative position, extends outwardly from a sidewall or other exterior surface portion of the housing and is structured to support and have mounted thereon one or more objects or containers of additional refuse material, etc. such that diverse objects or materials may be stored and transported both interiorly of the housing and exteriorly thereof, thereby increasing the capacity of the materials or objects stored on and transported by the container assembly while maintaining the objects or materials in a segregated relation to one another. The supplementary support structure, in certain embodiments of the present invention, may be disposed in a retracted orientation to define the stored position when the storage or transport of objects or materials on the exterior of the housing is not intended or required. Further, the housing is at least partially tapered such that at least two container assemblies can be concentrically stacked within one another when the supplementary support is in its stored position.

A TENTH EXAMPLE, U.S. Pat. No. 7,021,644, Issued on Apr. 4, 2006, to Master teaches a towing strap that has two ends, which may be permanently or releasably attached to an item to be towed. Each strap end which is releasably attached, includes a fastening mechanism, which permits a person to attach towing strap to the item to be towed. The permanent straps are molded, glued, or otherwise secured to the item to be towed.

AN ELEVENTH EXAMPLE, U.S. Pat. No. 7,101,142, Issued on Sep. 5, 2006, to Bik et al. teaches a hitch mountable refuse container transport device that has a vertical element supporting a telescoping mount, in an exemplary embodiment, that carries engagement keys on a horizontal bracket. Each key is adapted for engagement with an upper attachment element and a lower attachment element on the refuse container. Adjustment of the telescoping mount lifts the containers for transport.

A TWELFTH EXAMPLE, U.S. Pat. No. 7,217,078, Issued on May 15, 2007, to Short teaches a vehicle mounted carrier for lifting and securing in an elevated position waste receptacles and other articles for transport. A housing including a pair of side plates, a rear plate and a bottom plate, having apertures for mounting to a conventional trailer tow hitch assembly or to a vehicle bumper. A lever arm terminating at one end in a channel for receiving the article of transport and pivotally connected to the housing at the opposite end. A latch assembly is provided for securing the article of transport in an elevated position and for selectively releasing allowing the user to controllably lower and disengage the article of transport. The latch assembly includes a latch rod operably secured to a pair of springs secured to the lever arm and a pair of springs secured to the latch rod and to a lever handle. Lever arm stop element secured to the housing to limit the rotation of the lever arm.

A THIRTEENTH EXAMPLE, U.S. Patent Office Publication No. 2007/0170218, Published on Jul. 26, 2007, to Robb teaches a safe and easy transport of refuse cans such as standard residential refuse cans. The invention is a device that may be removably attached to a vehicle to receive a refuse can for transport. The present invention includes a removably mountable refuse can transport device that is mounted to a vehicle by a hitch engagement such as an insert to a conventional trailer hitch, a vertical support mounted with a base that supports a refuse can and a locking plate that rotates to retain a refuse can on the base to allow convenient transport of the refuse can. In one preferred embodiment of the present invention a lock and release control member is coupled to the locking plate. In an alternate embodiment of the invention the refuse can transporting includes a support frame that temporary attaches to a motor vehicle, an articulated support on the frame which moves up and down to move a retaining bracket into and out of engagement with a refuse can. Preferably, the retaining bracket includes a first side for contacting a refuse can and a second side for releasably retaining a refuse can and a spring for drawing the bracket up to retain the refuse can. Preferably, the refuse can sits on a support mounted on a lower end of the supporting frame during transport.

A FOURTEENTH EXAMPLE, U.S. Pat. No. 7,614,637, Issued on Nov. 10, 2009, to Kidd teaches a refuse container hitching device including a horizontally extending hitch insert, a vertically extending vertical member of adjustable length, a horizontally extending top member, a refuse container support plate that extending downwardly from the top member, and at least one locking strap for locking the handle of a refuse container to the support plate during towing.

It is apparent now that numerous innovations for transporting apparatuses have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a can caddy device that avoids the disadvantages of the prior art.

ANOTHER OBJECT of the present invention is to provide a can caddy device that is simple and inexpensive to manufacture.

STILL ANOTHER OBJECT of the present invention is to provide a can caddy device that is simple to use.

BRIEFLY STATED, STILL YET ANOTHER OBJECT of the present invention is to provide a can caddy device for lifting and transporting a refuse container by a back of the motor vehicle. The device comprises a horizontally extending hitch bar that is mounted into a standard hitch receiver on a back of the motor vehicle. A vertical track member has a bottom end secured to a distal end of the horizontally extending hitch bar. A vertical slide member has an inner portion which rides within the vertical track member. A mechanism on a top end of the vertical track member is for manually raising and lowering the vertical slide member. A structure on the vertical slide member is for engaging the refuse container.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a side elevational view of the present invention in use;

FIG. 2 is a front elevational view taken in the direction of arrow 2 in FIG. 1;

FIG. 3 is a plan view of the manual crank handle;

FIG. 4 is a cross sectional view taken along line 4-4 in FIG. 1, through the vertical trap member; and

FIG. 5 is a cross sectional view taken along line 5-5 in FIG. 1, through the vertical slide member.

### REFERENCE NUMERALS UTILIZED IN THE DRAWING

110 can caddy device
112 refuse container
112A handle portion of refuse container 112
112B cover of the refuse container
114 a back of a motor vehicle
116 horizontally extending hitch bar of device 110
118 standard hitch receiver of motor vehicle 114
120 vertical track member of device 110
122 bottom end of vertical track member 120
124 distal end of horizontally extending hitch bar 116
126 vertical slide member of device 110
128 inner portion of vertical slide member 126
130 manually raising and lowering mechanism of device 110
132 top end of vertical track member 120
134 engaging structure of device 110
136 angular brace member of device 110
138 support platform assembly of mechanism 130
140 top side end of vertical track member 120
142 winch of mechanism 130
142A primary gear
142B secondary gear is coupled to primary gear 142A
142C T-connector coupling to the secondary gear 142B
144 cable of mechanism 130
146 distal end of cable 144
148 top end of vertical slide member 126
150 crank handle of mechanism 130
152 vertical bar member of engaging structure 134
154 first side of vertical bar member 152
156 outer portion of vertical slide member 126
158 vertical T-shaped member of engaging structure 134
160 second side of vertical bar member 152
162 lower end of vertical bar member 152
164 lower portion of refuse container 112
166 lower horizontal bar member of engaging structure 134
168 upper horizontal bar member of engaging structure 134
170 upper end of vertical bar member 152
172 top seat assembly of engaging structure 134

### DETAILED DESCRIPTION OF THE PREFERRED EMBODIMENT

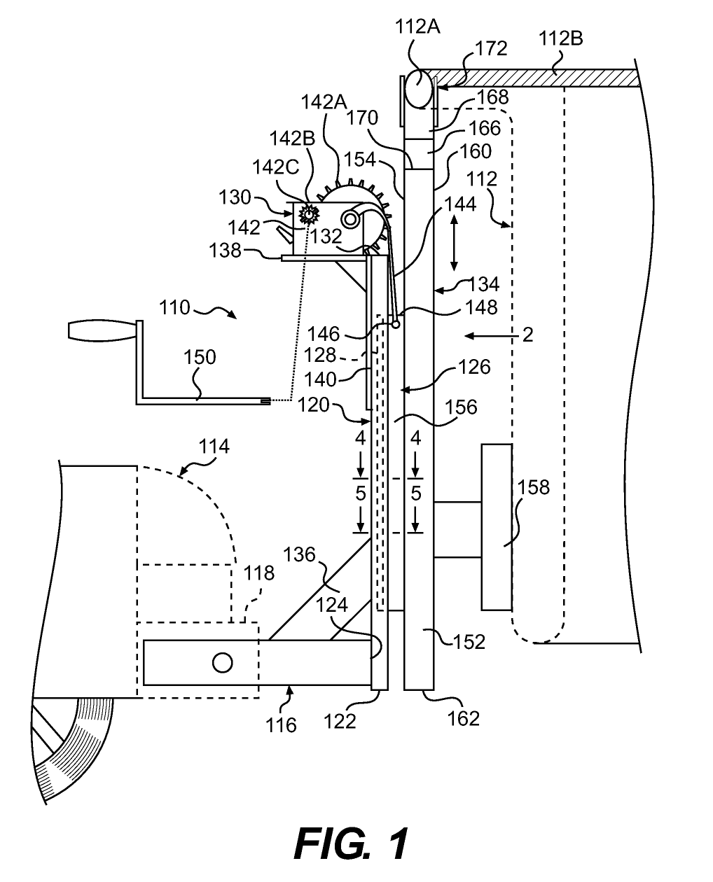

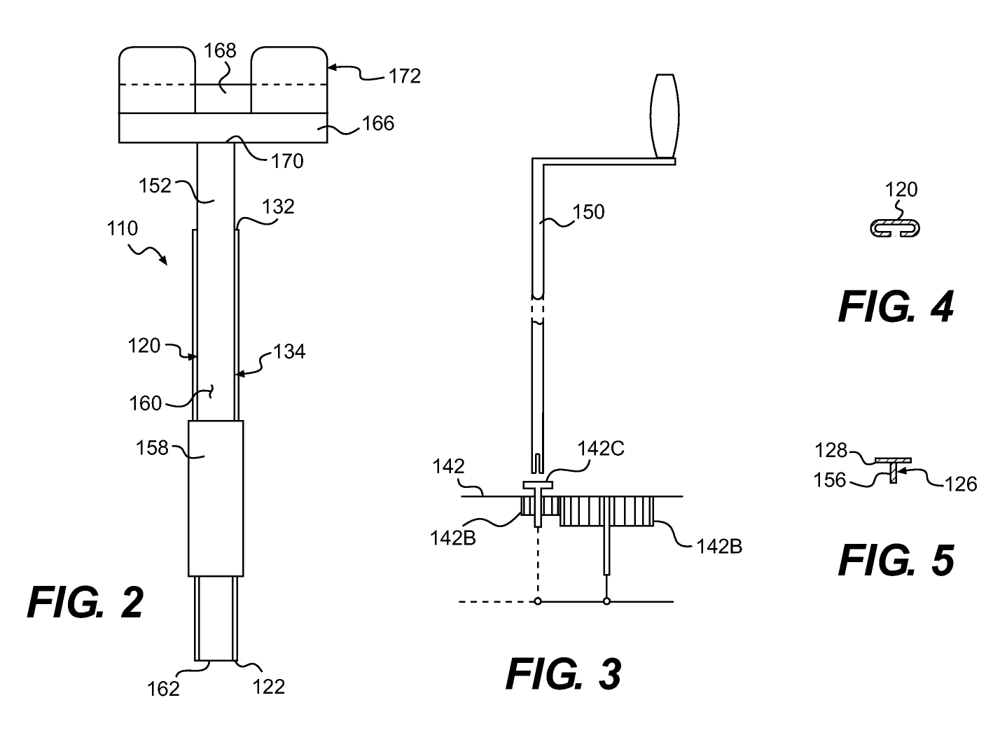

Referring now to the figures, in which like numerals indicate like parts, and particularly to FIGS. 1 through 5, and as such, will be discussed with reference thereto.

The present invention is a can caddy device 110 for lifting and transporting a refuse container 112 by a motor vehicle 114. The device 110 comprises a horizontally extending hitch bar 116 that is mounted into a standard hitch receiver 118 on the motor vehicle 114. A vertical track member 120 has a bottom end 122 secured to a distal end 124 of the horizontally extending hitch bar 116. A vertical slide member 126 has an inner portion 128 which rides within the vertical track member 120. A mechanism 130 on a top end 132 of the vertical track member 120 is for manually raising and lowering the vertical slide member 126. A structure 134 on the vertical slide member 126 is for engaging the refuse container 112.

An angular brace member 136 extends between the horizontally extending hitch bar 116 and the vertical track member 120 to provide additional support thereto. The cross section of the vertical track member 120 is in a generally C-shaped configuration (See FIG. 4). The cross section of the vertical slide member 126 is in a generally T-shaped configuration (See FIG. 5).

The manually raising and lowering mechanism 130 comprises a support platform assembly 138 mounted to a top side end 140 of the vertical track member 120. A winch 142 is affixed onto the support platform assembly 138. A cable 144 extends from the winch 142, with a distal end 146 of the cable 144 attached to a top end 148 of the vertical slide member 126. A crank handle 150, as shown in FIG. 3, removably engages with a T-connector 142C of the winch 142 to manually operate the winch 142 (with primary gear 142A and secondary gear 142B) in order to roll up or release the cable 144. The primary gear 142A has 31 teeth and diameter is 4 inches. The secondary gear 142B has 10 teeth and diameter is 1^{1/4} or 1^{1/2} inches. The teeth ratio of primary gear and secondary gear is 3:1. The gears 142A-142B are spring-loaded so the gears can stay firm (non-slipping, non-rotating freely) with the load up to 1000 Lbs, 1500 Lbs. Nevertheless, the gears do not need a lock or a locking mechanism to prevent the drop down of the refuse container 112. The winch mechanism 142 can be replaced with a reversible motor or a motorized superwinch (with minimum load is 500 lbs, 1000 lbs, 2000 lbs). The reversible motor can be controlled by a manual switch or a remote control.

The engaging structure 134 comprises a vertical bar member 152 having a first side 154 attached to an outer portion 156 of the vertical slide member 126. A vertical T-shaped member 158 is mounted to a second side 160 of the vertical bar member 152 near a lower end 162 thereof, so as to bear against a lower portion 164 of the refuse container 112. Two horizontal bar members 166, 168 are mounted one upon the other and transversely onto an upper end 170 of the vertical bar member 152. A top seat assembly 172 is affixed onto the upper horizontal bar member 168, so as to engage with a handle portion 112A of the refuse container 112.

The can caddy device 110 is used for transporting the standard city refuse containers 112 to the curb for pick-up. The device 110 can be attached to the motor vehicle hitch receiver 118 and is able to easily lift and transport full refuse containers 112 to the desired location. The device 110 is ideal for those with long driveways, the elderly, and the disabled. It can effectively eliminate the struggle associated with maneuvering heavy refuse container 112. The can caddy device 110 is maintenance free.

The can caddy device 110 is designed to effortlessly carry the refuse container 112 using the motor vehicle hitch receiver 118. The device 110 can be used with a one and a quarter inch or two inch hitch receiver 118. The device 110 fits securely into the hitch receiver 118 for operation. The refuse container 112 is pulled to the back of the motor vehicle 114 and against the device 110. The crank handle 150 is inserted into the winch 142. Turning the crank handle 150 counter-clockwise to lift the refuse container 112 clear off the ground using the cable 144. The refuse container 112 is lifted by its handle portion 112A. After the refuse container 112 is transported the device 110 is reversed in order to deposit the refuse container 112 at the curb.

The device 110 may be approximately thirty inches (13) in height, eleven inches (8) in length, and ten (10) inches wide. The device 110 can be made for any size hitch receiver 118 and may also be used with an adapter to accommodate the hitch receiver 118. The device 110 may be used with standard sized, city issued refuse containers 112. The can caddy is produced in the 2″ or 1¼″ tube, either can be used in with the opposite size receiver hitch by using an off the shelf 2″ to 1¼″ or 1¼″ to 2″ adapter. The exact specifications may vary.

It will be understood that each of the elements described above, or two or more together, may also find a useful application in other types of constructions differing from the types described above.

While the invention has been illustrated and described as embodiments of a can caddy device, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A can caddy device for lifting and transporting a refuse container by a motor vehicle, said device comprising:
a) a horizontally extending hitch bar that is mounted into a standard hitch receiver on a back of the motor vehicle;
b) a vertical track member having a bottom end secured to a distal end of said horizontally extending hitch bar;
c) a vertical slide member having an inner portion which rides within said vertical track member;
d) means on a top end of said vertical track member, for manually raising and lowering said vertical slide member; and
e) means on said vertical slide member for engaging the refuse container.

2. The device as recited in claim 1, further comprising an angular brace member extending between said horizontally extending hitch bar and said vertical track member to provide additional support thereto.

3. The device as recited in claim 1, wherein the cross section of said vertical track member is in a generally C-shaped configuration.

4. The device as recited in claim 1, wherein the cross section of said vertical slide member is in a generally T-shaped configuration.

5. The device as recited in claim 1, wherein said manually raising and lowering means comprises:
a) a support platform assembly mounted to a top side end of said vertical track member;
b) a winch mechanism affixed onto said support platform assembly;
c) a cable extending from said winch, with a distal end of said cable attached to a top end of said vertical slide member; and
d) a manual crank handle which removably engages with a T-connector of said winch to manually operated said winch in order to manually raise and lower said vertical slide member which carries the refuse container.

6. The device as recited in claim 1, wherein said engaging means comprises:
a) a vertical bar member having a first side attached to an outer portion of said vertical slide member;
b) a vertical T-shaped member mounted to a second side of said vertical bar member near a lower end thereof, so as to bear against a lower portion of the refuse container;
c) two horizontal bar members mounted one upon the other and transversely onto an upper end of said vertical bar member; and
d) a top seat assembly affixed onto said upper horizontal bar member, so as to engage with a handle portion of the refuse container.

7. The device as recited in claim 4, wherein the winch mechanism comprising two gears with teeth ratio 3:1.

8. The device as recited in claim 4, wherein the winch mechanism comprising a primary gear having 31 teeth and a secondary gear having 10 teeth.

9. The device as recited in claim 4, wherein the winch mechanism comprising a primary gear having 4 inch diameter and a secondary gear having is 1^{1/4} or 1^{1/2} inches.

10. The device as recited in claim 4, wherein the winch mechanism can have a motorized winch in order to replace manual crank handle.
